(19) United States
(12) Patent Application Publication
(10) Pub. No.: US 2025/0011548 A1
(43) Pub. Date: Jan. 9, 2025

(54) MANUFACTURING METHOD OF RESIN COMPOSITION

(71) Applicant: NAN YA PLASTICS CORPORATION, TAIPEI (TW)

(72) Inventors: Te-Chao Liao, Taipei (TW); HungFan Lee, Taipei (TW); Hng-Yi Chang, Taipei (TW); Wei-Ru Huang, Taipei (TW); Chia-Lin Liu, Taipei (TW)

(73) Assignee: NAN YA PLASTICS CORPORATION, TAPEI (TW)

(21) Appl. No.: 18/448,977

(22) Filed: Aug. 14, 2023

(30) Foreign Application Priority Data
Jul. 7, 2023 (TW) 112125565

(51) Int. Cl. C08J 3/07; C08K 3/011; C08K 3/34; C08K 5/541

(52) U.S. Cl. CPC C08J 3/07; C08K 3/011; C08K 3/34; C08K 5/541; C08J 2363/00; C08K 2201/014

(57) ABSTRACT

A manufacturing method of a resin composition includes the following steps. An inorganic filler, a first solvent, and a dispersant are mixed, wherein a material of the dispersant is silane and/or polysiloxane including an organic-philic end and an inorganic-philic end, and the dispersant and the inorganic filler undergo a dealcoholization condensation reaction reaction to form a dispersion including a modified inorganic filler. The organic-philic end includes a carbonyl group, an epoxy group, and/or an amine group. Epoxy resin is dissolved into the dispersion.

### CROSS-REFERENCE TO RELATED APPLICATION

This application claims the priority benefit of Taiwan application serial no. 112125565, filed on Jul. 7, 2023. The entirety of the above-mentioned patent application is hereby incorporated by reference herein and made a part of this specification.

### BACKGROUND

### Technical Field

The invention relates to a manufacturing method of a resin composition.

### Description of Related Art

Copper-clad laminate is an electronic component substrate, which is composed of multiple insulating layers and copper foil layers stacked alternately. Usually, the copper-clad laminate uses a special resin material as an insulating layer, and a conductive hole through the insulating layer is formed through electroplating technology, so as to electrically connect different layers of copper foil together.

With the development of 5G communication technology, the requirements for the characteristics of the copper-clad laminate (such as low dielectric properties and dielectric loss) continue to increase. In order to optimize the copper-clad laminate, many manufacturers add an inorganic filler into a resin material to enhance properties such as the mechanical strength and the thermal stability of the resin material. However, due to the small particle size of the inorganic filler and the high viscosity of resin, it is difficult for the inorganic filler to be evenly dispersed in the resin.

### SUMMARY

The invention provides a manufacturing method of a resin composition, which can improve the evenness of an inorganic filler.

At least one embodiment of the invention provides a manufacturing method of a resin composition, including the following steps. An inorganic filler, a first solvent, and a dispersant are mixed. A material of the dispersant includes silane and/or polysiloxane including an organic-philic end and an inorganic-philic end, and the dispersant and the inorganic filler undergo an alcoholysis condensation reaction to form a dispersion including a modified inorganic filler. The organic-philic end includes a carbonyl group, an epoxy group, and/or an amine group. Epoxy resin is dissolved into the dispersion.

### BRIEF DESCRIPTION OF THE DRAWINGS

FIG. 1 is a schematic diagram of a manufacturing method of a resin composition according to an embodiment of the invention.

FIG. 2 is a schematic diagram of a manufacturing method of a resin composition according to an embodiment of the invention.

FIG. 3 is a schematic diagram of a manufacturing method of a resin composition according to an embodiment of the invention.

FIG. 4 is a schematic diagram of a manufacturing method of a resin composition according to an embodiment of the invention.

FIG. 5 is a schematic diagram of a manufacturing method of a resin composition according to an embodiment of the invention.

### DESCRIPTION OF THE EMBODIMENTS

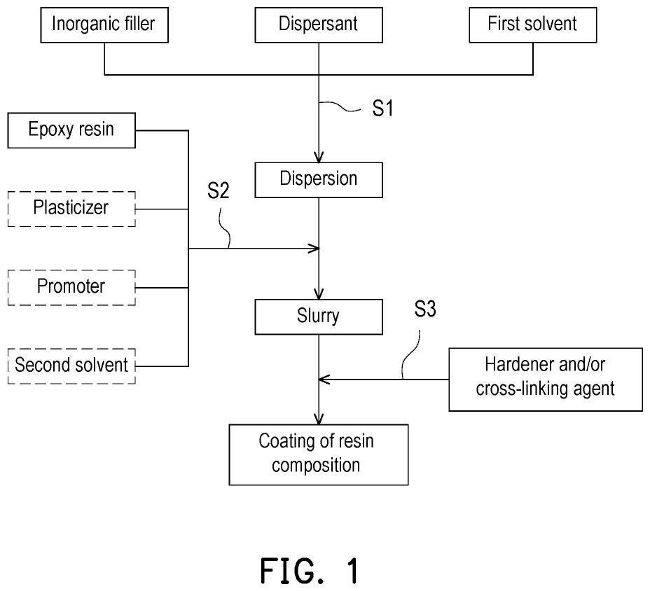

FIG. 1 is a schematic diagram of a manufacturing method of a resin composition according to an embodiment of the invention. Referring to FIG. 1, in step S1, an inorganic filler, a first solvent, and a dispersant are mixed. For example, the inorganic filler, the first solvent, and the dispersant are mixed by means of a bead mill, a flowjet mixer, a high-speed impeller, high-pressure wet micronization, a ball mill, a pain shaker, a microfluidizer, ultrasonic dispersion, a sand mill, a roller mill, a sander, a high-speed homogeneous mixer, etc. to form a dispersion.

In some embodiments, the dispersion includes 53 wt % to 80 wt % of the inorganic filler, 19.9 wt % to 45 wt % of the first solvent, and 0.1 wt % to 2.0 wt % of the dispersant. In some embodiments, based on 100 parts by weight of the inorganic filler, a content of the dispersant is 0.125 parts by weight to 3.773 parts by weight.

In some embodiments, the first solvent includes at least one of butanone, cyclohexanone, and propylene glycol methyl ether or a combination thereof and other solvents.

In some embodiments, the inorganic filler includes silicon oxide (SiOₓ), such as spherical silicon oxide, silicon flakes, or other types of silicon oxide. In some embodiments, the average particle size of the spherical silicon oxide is 0.1 μm to 1.2 μm.

A material of the dispersant includes silane and/or polysiloxane including an organic-philic end and an inorganic-philic end. The organic-philic end includes a carbonyl group, an epoxy group, and/or an amine group, and the inorganic-philic end includes a group which can dealcoholize and condense with the epoxy group. For example, the material of the dispersant is represented by any one of following Chemical Structure (1) to Chemical Structure (4):

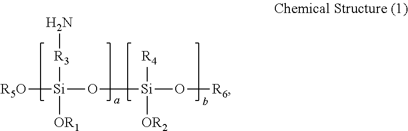

wherein in Chemical Structure (1), R₁ and R₂ are each independently a methyl group or an ethyl group, R₃ is a long carbon chain with 2 to 6 carbons, an ether group, or a phenyl group, R₄ is an alkyl group with 1 to 3 carbons, R₅ and R₆ are each independently a methyl group or an ethyl group, a is a positive integer, and b is a positive integer;

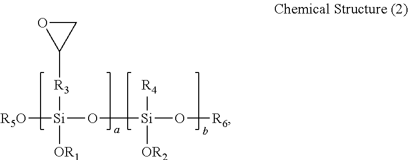

wherein in Chemical Structure (2), R₁ and R₂ are each independently a methyl group or an ethyl group, R₃ is a long carbon chain with 2 to 6 carbons, an ether group, or a phenyl group, R₄ is an alkyl group with 1 to 3 carbons, R₅ and R₆ are each independently a methyl group or an ethyl group, a is a positive integer, and b is a positive integer;

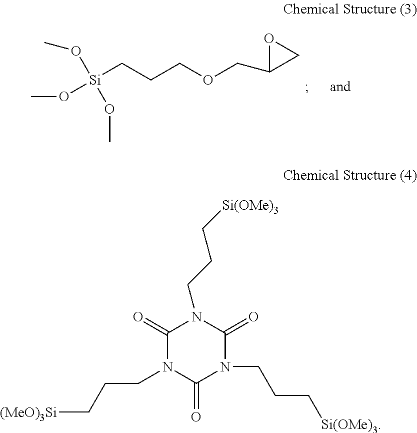

In step S1, the dispersant and the inorganic filler undergo an alcoholysis condensation reaction to form a dispersion including a modified inorganic filler.

Next, referring to step S2, epoxy resin is dissolved into the dispersion. In some embodiments, a second solvent, the epoxy resin, a plasticizer, and a promoter are optionally added together into the dispersion, and then are mixed by means of the bead mill, the flowjet mixer, the high-speed impeller, the high-pressure wet micronization, the ball mill, the pain shaker, the microfluidizer, the ultrasonic dispersion, the sand mill, the roller mill, the sander, the high-speed homogeneous mixer, etc. to form a slurry.

In some embodiments, the slurry includes 49.6 wt % to 74.87 wt % of the dispersion, 11.9 wt % to 37.17 wt % of the second solvent, 2.65 wt % to 10.58 wt % of the epoxy resin, 2.65 wt % to 10.58 wt % of the plasticizer, and 0.05 phr to 0.8 phr of the promoter. In some embodiments, based on 100 parts by weight of the inorganic filler, the content of the epoxy resin is 7 parts by weight to 27 parts by weight. In some embodiments, based on 100 parts by weight of the inorganic filler, the content of the plasticizer is 7 parts by weight to 27 parts by weight.

In some embodiments, the second solvent includes at least one of toluene, butanone, and cyclohexanone or a combination thereof and other solvents. The second solvent may be used to adjust the solid content and the viscosity of the slurry.

In some embodiments, the epoxy resin includes at least one of naphthalene ring epoxy resin, novolak epoxy resin, ester epoxy resin, and bisphenol F epoxy resin. In some embodiments, when the organic-philic end of the material of the dispersant includes the amine group, the epoxy group of the epoxy resin undergoes a ring-opening reaction and cross-links with the amine group of the organic-philic end of the dispersant. In this case, the organic-philic end of the dispersant is connected to the epoxy resin, and the inorganic-philic end of the dispersant is connected to the inorganic filler, so that the modified inorganic filler (including the inorganic filler and the dispersant located on its surface) is evenly dispersed. In some embodiments, when the organic-philic end of the material of the dispersant includes a carbonyl group or an epoxy group, since the epoxy group of the dispersant has preferable compatibility with the epoxy resin, the modified inorganic filler can be preferably dispersed and is not easily agglomerated together in the epoxy resin.

In the embodiments described herein, the epoxy resin is dissolved into the dispersion after the dispersion including the modified inorganic filler is formed. If the inorganic filler is directly mixed with the epoxy resin, it is difficult for the inorganic filler to be fully dispersed due to the high viscosity of the epoxy resin. In addition, the organic-philic end and the inorganic-philic end of the dispersant can reduce the probability of the inorganic filler agglomerating together. Therefore, the embodiments described herein can fully improve the evenness of the inorganic filler. For example, the inorganic filler in the slurry can be kept in suspension even after standing for 48 hours.

In some embodiments, the plasticizer includes at least one of materials such as bismaleimide resin, a macromolecule of amine, and a macromolecule of the epoxy group. In some embodiments, the promoter includes at least one of materials such as imidazole and a phosphorus-based promoter.

In some embodiments, other types of silanes may be additionally added into the dispersion in step S2. The silane used here is used to improve adhesion between a subsequently formed coating of the resin composition and a substrate, and may include different materials from the silane used in the dispersant. For example, the silane added in step S2 optionally does not include the organic-philic end and the inorganic-philic end. For example, the silane added in step S2 includes at least one of materials such as an epoxy functional group and an amine functional group.

Referring to step S3, after the second solvent, the epoxy resin, and the promoter are added into the dispersion, a hardener and/or a cross-linking agent are added into the slurry. After mixing, the slurry is coated on the substrate to form the coating of the resin composition.

In some embodiments, based on 100 parts by weight of the epoxy resin, the content of the hardener is 3 parts by weight to 20 parts by weight. In some embodiments, based on 100 parts by weight of the epoxy resin, the content of the cross-linking agent is 20 parts by weight to 70 parts by weight.

In some embodiments, the hardener includes at least one of materials such as ester hardener, amine hardener, and phenolic hardener. In some embodiments, the cross-linking agent includes at least one of materials such as tertiary amine, benzoxazine resin, and aromatic amine.

In some embodiments, since the inorganic filler is evenly dispersed in the coating of the resin composition, the coating of the resin composition has a higher glass transition temperature (for example, greater than 320° C.), a lower thermal expansion coefficient (for example, less than 4 ppm/° C.), and a low water absorption rate (for example, less than or equal to 0.45%).

Table 1 provides a comparison of the characteristics of the slurry and the coating of the resin composition obtained in Example 1 to Example 4 of the invention and Comparative Example 1. In Example 1 to Example 4, the dispersion including the dispersant, the first solvent, and the inorganic filler was first formed, and then the resin material was mixed with the dispersion to form the slurry. However, in Comparative Example 1, the inorganic filler was directly mixed with the resin material. In Table 1, the samples after the pressure cooker test (PCT) saturated steam test were soaked in a tin furnace at 288° C., and no delamination for 10 minutes means that the heat resistance passed the standard.

TABLE 1

| | | Comparative | | | | | | | | | |
|---|---|---|---|---|---|---|---|---|---|---|---|
| | | Example 1 | | Example 1 | | Example 2 | | Example 3 | | Example 4 | |
| Resin | Epoxy resin | 52 | wt % | 52 | wt % | 52 | wt % | 52 | wt % | 52 | wt % |
| composition | Hardener | 10 | wt % | 10 | wt % | 10 | wt % | 10 | wt % | 10 | wt % |
| ratio (the total of | Cross- | 38 | wt % | 38 | wt % | 38 | wt % | 38 | wt % | 38 | wt % |
| epoxy resin, | linking | | | | | | | | | | |
| hardener, and | agent | | | | | | | | | | |
| cross-linking | | | | | | | | | | | |
| agent is | | | | | | | | | | | |
| 100 wt %) | | | | | | | | | | | |
| Promoter | | 1.2 | phr | 1.2 | phr | 1.2 | phr | 1.2 | phr | 1.2 | phr |
| Silane added in step S2 | | 0.5 | phr | 0.5 | phr | 0.5 | phr | 0.5 | phr | 0.5 | phr |
| Inorganic filler ratio (the total | | 70 | wt % | 70 | wt % | 70 | wt % | 70 | wt % | 70 | wt % |
| of epoxy resin, hardener, and | | | | | | | | | | | |
| cross-linking agent is 100 wt %) | | | | | | | | | | | |
| Dispersant | | None | | Chemical | | Chemical | | Chemical | | Chemical | |
| | | | | structure (1) | | structure (2) | | structure (3) | | structure (4) | |
| Composition of inorganic filler | | Silicon oxide | | Silicon oxide | | Silicon oxide | | Silicon oxide | | Silicon oxide | |
| | | unmodified by | | modified by | | modified by | | modified by | | modified by | |
| | | dispersant | | dispersant | | dispersant | | dispersant | | dispersant | |
| B-stage temperature of coating | | 120° | C. | 120° | C. | 120° | C. | 120° | C. | 120° | C. |
| of resin composition | | | | | | | | | | | |
| Tg (Dynamic mechanical | | 285° | C. | 342° | C. | 335° | C. | 322° | C. | 322° | C. |
| analyzer) | | | | | | | | | | | |
| Saturated steam | Water | 1.01% | | 0.45% | | 0.88% | | 0.45% | | 0.60% | |
| test | absorption | | | | | | | | | | |
| | rate | | | | | | | | | | |
| | Heat | Pass | | Pass | | Pass | | Pass | | Pass | |
| | resistance | | | | | | | | | | |

| Suspension of solid composition | Precipitation | Evenly | Evenly | Evenly | Evenly |
|---|---|---|---|---|---|
| in slurry after standing for 24 | appearing | dispersed | dispersed | dispersed | dispersed |
| hours | | | | | |

It can be seen from Table 1 that the coatings of the resin compositions obtained in Example 1 to Example 4 have lower water absorption rates, and the suspension of the solid compositions in the slurries is preferred. In addition, in Example 1 to Example 4, the resin compositions obtained in Example 1 and Example 3 have lower water absorption rates, and the resin compositions obtained in Example 1 and Example 2 have higher T_{g}. In Comparative Example 1 to Example 4, it can be seen that the material of the dispersant with Chemical Structure (1) added is preferred, and the obtained resin has the advantages of low water absorption rate and high T_{g} at the same time, because the dispersant of Chemical Structure 1 has preferred cross-linking with the inorganic filler and the resin.

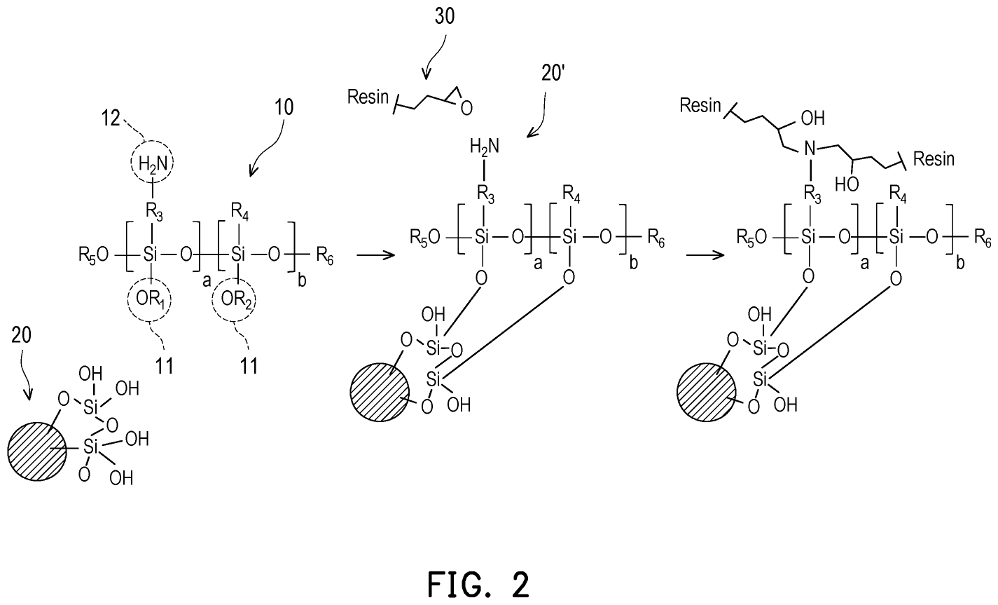

FIG. 2 is a schematic diagram of a manufacturing method of a resin composition according to an embodiment of the invention. It is noted here that the embodiment in FIG. 2 inherits part of the content of the embodiment in FIG. 1. Referring to FIG. 2, in this embodiment, a dispersant 10 is represented by Chemical Structure (1). The dispersant 10 has an inorganic-philic end 11 and an organic-philic end 12.

First, the dispersant 10 is mixed with an inorganic filler 20 (see step S1 in FIG. 1). The inorganic-philic end 11 of the dispersant 10 and the inorganic filler 20 undergo the alcoholysis condensation reaction to form a modified inorganic filler 20′.

Next, an epoxy resin 30 is mixed with the modified inorganic filler 20′ (see step S2 in FIG. 1). The epoxy group of the epoxy resin 30 undergoes the ring-opening reaction and cross-links with the amine group of the organic-philic end 12.

In this embodiment, the epoxy group of the epoxy resin 30 including a three-membered ring is taken as an example, but the invention is not limited thereto. In other embodiments, the epoxy group of the epoxy resin 30 includes a three-membered ring, a four-membered ring, or a five-membered ring.

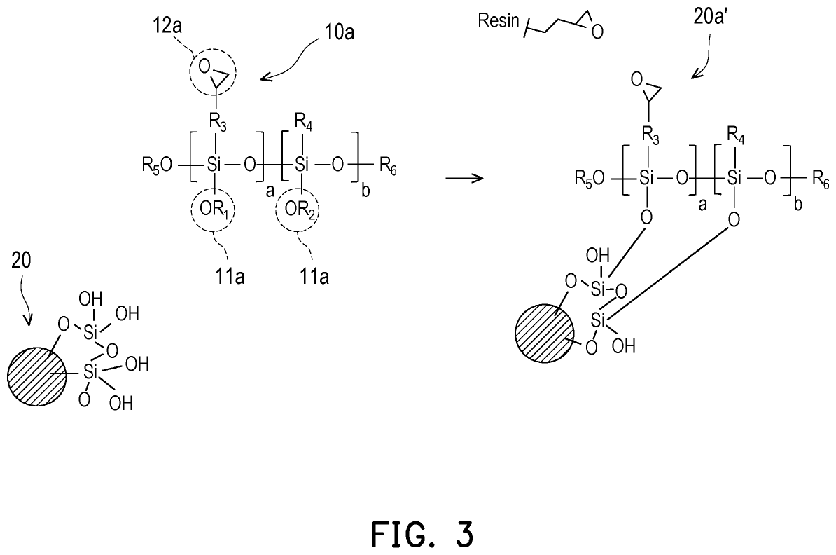

FIG. 3 is a schematic diagram of a manufacturing method of a resin composition according to an embodiment of the invention. It is noted here that the embodiment in FIG. 3 inherits part of the content of the embodiment in FIG. 1. Referring to FIG. 3, in this embodiment, a dispersant 10a is represented by Chemical Structure (2). The dispersant 10a has an inorganic-philic end 11a and an organic-philic end 12a.

First, the dispersant 10a is mixed with the inorganic filler 20 (see step S1 in FIG. 1). The inorganic-philic end 11a of the dispersant 10a and the inorganic filler 20 undergo the alcoholysis condensation reaction to form a modified inorganic filler 20a′.

Next, the epoxy resin 30 is mixed with the modified inorganic filler 20a′ (see step S2 in FIG. 1). The epoxy resin 30 and the organic-philic end 12a of the dispersant 10a both include epoxy groups, so the modified inorganic filler 20a′ has preferable compatibility with the epoxy resin 30, so that the modified inorganic filler 20a′ can be evenly dispersed in the epoxy resin 30. In this embodiment, the epoxy groups of the epoxy resin 30 and the organic end 12a of the dispersant 10a both including three-membered rings is taken as an example, but the invention is not limited thereto. In other embodiments, the epoxy groups of the epoxy resin 30 and the organic-philic end 12a of the dispersant 10a include three-membered rings, four-membered rings, or five-membered rings. In some embodiments, the epoxy resin 30 and the organic-philic end 12a of the dispersant 10a include different epoxy groups.

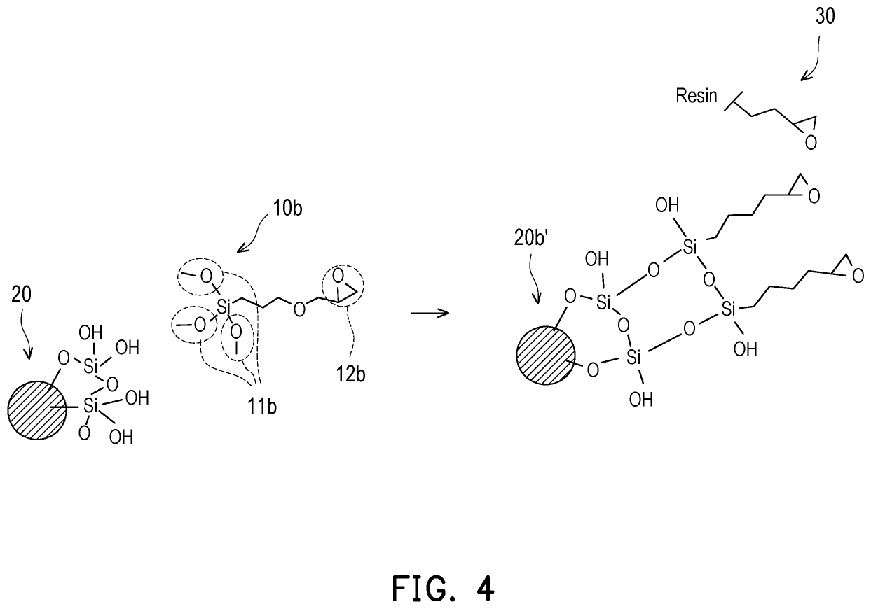

FIG. 4 is a schematic diagram of a manufacturing method of a resin composition according to an embodiment of the invention. It is noted here that the embodiment in FIG. 4 inherits part of the content of the embodiment in FIG. 1. Referring to FIG. 4, in this embodiment, a dispersant 10b is represented by Chemical Structure (3). The dispersant 10b has an inorganic-philic end 11b and an organic-philic end 12b.

First, the dispersant 10b is mixed with the inorganic filler 20 (see step S1 in FIG. 1). The inorganic-philic end 11b of the dispersant 10b and the inorganic filler 20 undergo the alcoholysis condensation reaction to form a modified inorganic filler 20b′.

In this embodiment, the inorganic-philic ends 11b of the dispersants 10b also undergo the alcoholysis condensation reaction with each other, so that the dispersants 10b are connected to each other.

Next, the epoxy resin 30 is mixed with the modified inorganic filler 20 b′ (see step S2 in FIG. 1). The epoxy resin 30 and the organic-philic end 12b of the dispersant 10b both include the epoxy groups. Therefore, the modified inorganic filler 20b′ has preferable compatibility with the epoxy resin 30, so that the modified inorganic filler 20b′ can be evenly dispersed in the epoxy resin 30. In this embodiment, the epoxy groups of the epoxy resin 30 and the organic-philic end 12b of the dispersant 10b both including three-membered rings is taken as an example, but the invention is not limited thereto. In other embodiments, the epoxy groups of the epoxy resin 30 and the organic-philic end 12b of the dispersant 10b include three-membered rings, four-membered rings, or five-membered rings. In some embodiments, the epoxy resin 30 and the organic-philic end 12b of the dispersant 10b include different epoxy groups.

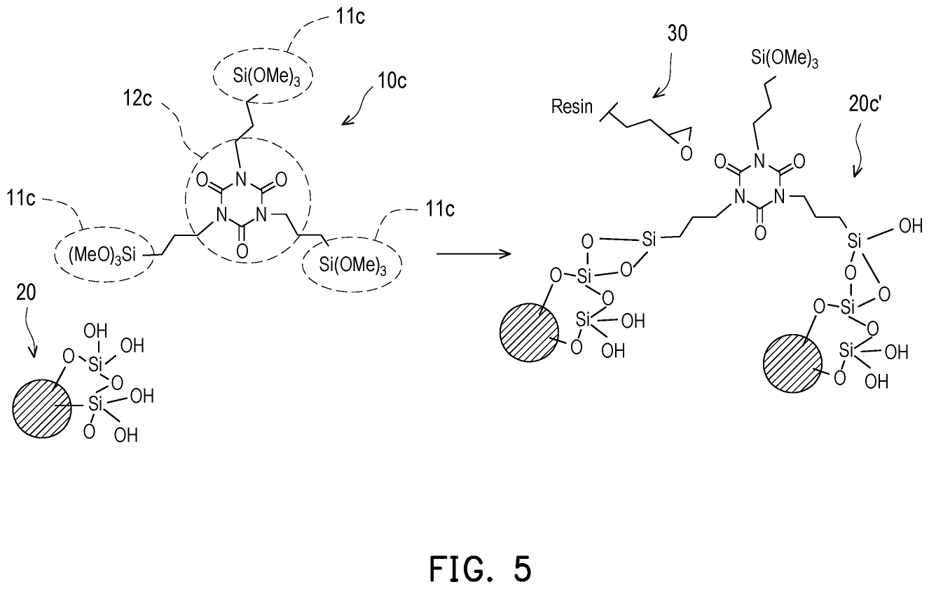

FIG. 5 is a schematic diagram of a manufacturing method of a resin composition according to an embodiment of the invention. It is noted here that the embodiment in FIG. 5 inherits part of the content of the embodiment in FIG. 1. Referring to FIG. 5, in this embodiment, a dispersant 10c is represented by Chemical Structure (4). The dispersant 10c has an inorganic-philic end 11c and an organic-philic end 12c.

First, the dispersant 10c is mixed with the inorganic filler 20 (see step S1 in FIG. 1). The inorganic-philic end 11c of the dispersant 10c and the inorganic filler 20 undergo the alcoholysis condensation reaction to form a modified inorganic filler 20c′.

Next, the epoxy resin 30 is mixed with the modified inorganic filler 20c′ (see step S2 in FIG. 1). The epoxy resin 30 includes the epoxy group and the organic-philic end 12b of the dispersant 10c includes a carbonyl group, so the modified inorganic filler 20c′ has preferable compatibility with the epoxy resin 30, so that the modified inorganic filler 20c′ can be evenly dispersed in the epoxy resin 30.

1. A manufacturing method of a resin composition, comprising:
mixing an inorganic filler, a first solvent, and a dispersant, wherein a material of the dispersant is silane and/or polysiloxane comprising an organic-philic end and/or an inorganic-philic end, and the dispersant and the inorganic filler undergo a dealcoholization condensation reaction to form a dispersion comprising a modified inorganic filler, wherein the organic-philic end comprises a carbonyl group, an epoxy group, and/or an amine group; and
dissolving epoxy resin into the dispersion.

2. The manufacturing method of the resin composition according to claim 1, wherein the organic-philic end of the material of the dispersant comprises an amine group, and an epoxy group of the epoxy resin undergoes a ring-opening reaction and cross-links with the amine group of the organic-philic end.

3. The manufacturing method of the resin composition according to claim 1, further comprising:
adding a second solvent, the epoxy resin, a plasticizer, and a promoter together into the dispersion.

4. The manufacturing method of the resin composition according to claim 3, further comprising adding a hardener and/or a cross-linking agent after adding the second solvent, the epoxy resin, and the promoter into the dispersion.

5. The manufacturing method of the resin composition according to claim 4, wherein the first solvent comprises at least one of butanone, cyclohexanone, and propylene glycol methyl ether, and the second solvent comprises at least one of toluene, butanone, and cyclohexanone.

6. The manufacturing method of the resin composition according to claim 1, wherein the material of the dispersant is represented by any one of following Chemical Structure (1) to Chemical Structure (4): 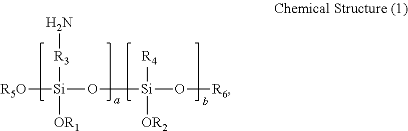
wherein in Chemical Structure (1), R₁ and R₂ are each independently a methyl group or an ethyl group, R₃ is a long carbon chain with 2 to 6 carbons, an ether group, and a phenyl group, R₄ is an alkyl group with 1 to 3 carbons, R₅ and R₆ are each independently a methyl group or an ethyl group, a is a positive integer, and b is a positive integer; 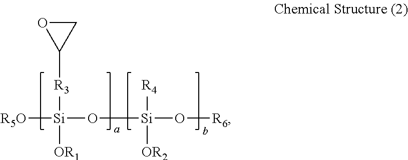
wherein in Chemical Structure (2), R₁ and R₂ are each independently a methyl group or an ethyl group, R₃ is a long carbon chain with 2 to 6 carbons, an ether group, and a phenyl group, R₄ is an alkyl group with 1 to 3 carbons, R₅ and R₆ are each independently a methyl group or an ethyl group, a is a positive integer, and b is a positive integer;

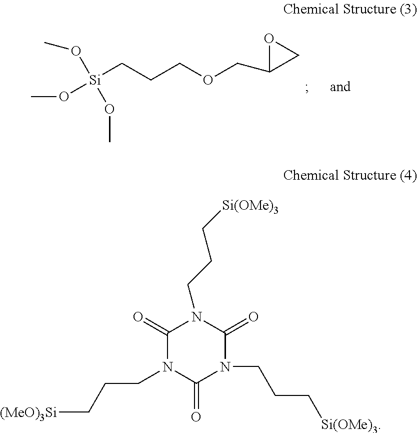

7. The manufacturing method of the resin composition according to claim 1, wherein the epoxy resin comprises at least one of naphthalene ring epoxy resin, novolac epoxy resin, ester epoxy resin, and bisphenol F epoxy resin.

8. The manufacturing method of the resin composition according to claim 1, wherein a content of the dispersant is 0.1 parts by weight to 1.5 parts by weight based on 100 parts by weight of the inorganic filler.

9. The manufacturing method of the resin composition according to claim 1, wherein a content of the epoxy resin is 8 parts by weight to 55 parts by weight based on 100 parts by weight of the inorganic filler.

10. The manufacturing method of the resin composition according to claim 1, wherein the inorganic filler comprises silicon oxide.
